(19) United States
(12) Patent Application Publication
(10) Pub. No.: US 2026/0328641 A1
(43) Pub. Date: Oct. 22, 2026

(54) DIAGNOSIS DEVICE, DIAGNOSIS METHOD, AND NON-TRANSITORY COMPUTER-READABLE MEDIUM

(71) Applicant: NEC Corporation, Tokyo (JP)

(72) Inventors: Shigeru KASAI, Tokyo (JP); Kouji Umeda, Tokyo (JP); Shohei Kinoshita, Tokyo (JP); Hajime Endo, Tokyo (JP)

(73) Assignee: NEC Corporation, Tokyo (JP)

(21) Appl. No.: 19/529,353

(22) Filed: Feb. 4, 2026

(30) Foreign Application Priority Data
Mar. 26, 2025 (JP) 2025-050941

(51) Int. Cl. G01M 7/02; G01H 9/00; G09F 15/00

(52) U.S. Cl. CPC G01M 7/025; G01H 9/004; G09F 15/00

(57) ABSTRACT

A diagnosis device according to the present disclosure includes at least one memory storing instructions and at least one processor that executes the instructions to acquire optical fiber data indicating vibration sensed using an optical fiber laid along a road and acquire acceleration data indicating an acceleration measured by an acceleration sensor installed on a road accessory installed on the road, estimate a time section in which a vehicle has passed through a road section near the road accessory, using the optical fiber data and determine the estimated time section as an analysis target section in which the acceleration data is analyzed, and diagnose a state of the road accessory, using the acceleration data in the analysis target section.

### INCORPORATION BY REFERENCE

This application is based upon and claims the benefit of priority from Japanese patent application No. 2025-050941, filed on Mar. 26, 2025, the disclosure of which is incorporated herein in its entirety by reference.

### TECHNICAL FIELD

The present disclosure relates to a diagnosis device, a diagnosis method, and a non-transitory computer-readable medium.

### BACKGROUND ART

Road accessories such as information boards are installed on a road. The information board is installed for a purpose of providing information on the road (traffic congestion, traffic accident, weather, or the like).

Recently, a technology for diagnosing a state of the road accessories has been proposed. For example, JP 2021-021647 A discloses a technology for diagnosing a state of the information board.

According to the technology disclosed in JP 2021-021647 A, an acceleration sensor is installed on a support post or an information board attached to the support post, and a strain measurement sensor that is temporarily used is installed on the support post. Then, acceleration information and strain information are respectively acquired from the acceleration sensor and the strain measurement sensor at the same time, and a correlation between the acceleration information and the strain information is calculated in advance. Thereafter, by generating the strain information from the acceleration information, using the correlation calculated in advance, a stress applied to the support post is estimated, and an accumulated fatigue of the information board is diagnosed, using the estimated stress.

### SUMMARY

However, the technology disclosed in JP 2021-021647 A has the following problems.

A correlation between an acceleration and strain is affected by an excitation force that swings the information board. Here, the cause of generating the excitation force includes an environmental factor such as wind and a traffic stream factor associated with vehicle traveling. Therefore, in a case where the two are not distinguished, there is a possibility that an erroneous correlation is calculated. For example, the excitation force caused by the environment is sufficiently smaller than the excitation force caused by the traffic stream. Therefore, in the correlation between the acceleration and the strain in a case where the excitation force caused by the environment is received, there is a possibility that smaller strain is estimated with respect to the acceleration. If the erroneous correlation is used, a diagnosis performance of the information board deteriorates.

Since the correlation itself changes if the state of the information board changes, the diagnosis performance of the information board deteriorates.

In view of the above problems, an object of the present disclosure is to provide a diagnosis device, a diagnosis method, and a non-transitory computer-readable medium capable of contributing to improving a diagnosis performance of a road accessory.

A diagnosis device according to one aspect includes
at least one memory storing instructions and
at least one processor executes the instructions to
acquire optical fiber data indicating vibration sensed using an optical fiber laid along a road and acquire acceleration data indicating an acceleration measured by an acceleration sensor installed on a road accessory installed on the road,
estimate a time section in which a vehicle has passed through a road section near the road accessory, using the optical fiber data and determine the estimated time section as an analysis target section in which the acceleration data is analyzed, and
diagnose a state of the road accessory, using the acceleration data in the analysis target section.

A diagnosis method according to one aspect
executed by a diagnosis device, includes
acquiring optical fiber data indicating vibration sensed using an optical fiber laid along a road and acquiring acceleration data indicating an acceleration measured by an acceleration sensor installed on a road accessory installed on the road,
estimating a time section in which a vehicle has passed through a road section near the road accessory, using the optical fiber data and determining the estimated time section as an analysis target section in which the acceleration data is analyzed, and
diagnosing a state of the road accessory, using the acceleration data in the analysis target section.

A non-transitory computer-readable medium according to one aspect stores a program for causing a computer to execute
a procedure for acquiring optical fiber data indicating vibration sensed using an optical fiber laid along a road and acquiring acceleration data indicating an acceleration measured by an acceleration sensor installed on a road accessory installed on the road,
a procedure for estimating a time section in which a vehicle has passed through a road section near the road accessory, using the optical fiber data and determining the estimated time section as an analysis target section in which the acceleration data is analyzed, and
a procedure for diagnosing a state of the road accessory, using the acceleration data in the analysis target section.

According to the above aspect, an effect is obtained that it is possible to provide a diagnosis device, a diagnosis method, and a non-transitory computer-readable medium capable of contributing to improve a diagnosis performance of a road accessory.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram for explaining an outline of the present disclosure;

FIG. 2 is a block diagram illustrating a configuration example of a diagnosis system according to the present disclosure;

FIG. 3 is a diagram for explaining an operation example for determining an analysis target section, in the diagnosis device according to the present disclosure;

FIG. 4 is a diagram for explaining an operation example 1 for diagnosing a state of an information board, in the diagnosis device according to the present disclosure;

FIG. 5 is a diagram for explaining an operation example 2 for diagnosing the state of the information board, in the diagnosis device according to the present disclosure;

FIG. 6 is a diagram for explaining an operation example 3 for diagnosing the state of the information board, in the diagnosis device according to the present disclosure;

FIG. 7 is a flowchart illustrating an example of a flow of an operation of the diagnosis device according to the present disclosure;

FIG. 8 is a block diagram illustrating a configuration example of the diagnosis device according to the present disclosure; and

FIG. 9 is a block diagram illustrating a hardware configuration example of a computer that achieves the diagnosis device according to the present disclosure.

### EXAMPLE EMBODIMENT

Hereinafter, example embodiments of the present disclosure will be described with reference to the drawings. The following description and drawings are omitted and simplified as appropriate for clarity of description. In the following drawings, the same elements will be denoted by the same reference signs, and redundant description will be omitted as necessary.

### Outline of Present Disclosure

Prior to describing the example embodiment of the present disclosure, an outline of the present disclosure will be described.

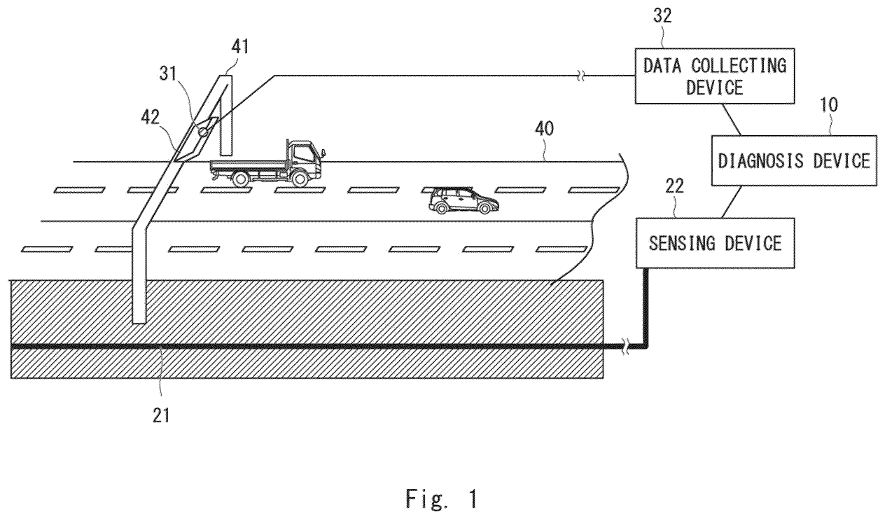

FIG. 1 is a diagram for explaining the outline of the present disclosure.

As illustrated in FIG. 1, the present disclosure diagnoses a state of a road accessory installed on a road 40. Hereinafter, it is assumed that the road accessory be an information board 42.

The information board 42 is installed on the road 40. In FIG. 1, the information board 42 is attached to and installed on a support post 41. However, a method for installing the information board 42 is not limited to this.

An acceleration sensor 31 is installed on the information board 42. For example, the acceleration sensor 31 is installed on an outer periphery or inside the information board 42. However, a method for installing the acceleration sensor 31 is not limited to this. A data collecting device 32 collects acceleration data indicating an acceleration measured by the acceleration sensor 31.

On the road 40, an optical fiber 21 is laid along the road 40. A sensing device 22 senses vibration generated at each position along the road 40, using the optical fiber 21 and generates optical fiber data indicating the sensed vibration.

A diagnosis device 10 estimates a traveling state of a vehicle on the road 40, using the optical fiber data. Specifically, the diagnosis device 10 estimates a time section in which the vehicle has passed through a road section immediately below the information board 42. Then, the diagnosis device 10 determines the estimated time section as an analysis target section in which the acceleration data is analyzed. Thereafter, the diagnosis device 10 diagnoses a state of the information board 42, using the acceleration data in the analysis target section.

As described above, according to the present disclosure, the state of the information board 42 can be diagnosed, using the acceleration data in the time section in which the vehicle travels immediately below the information board 42 and the information board 42 receives an excitation force caused by a traffic stream. From this, since erroneous diagnosis of the information board 42 caused by an environmental factor such as wind can be reduced, it is possible to contribute to improve a diagnosis performance of the information board 42.

Hereinafter, example embodiments of the present disclosure will be described.

### First Example Embodiment

In a first example embodiment, it is assumed that a road accessory be an information board 42.

First, a configuration of a diagnosis system 1 according to the present disclosure will be described.

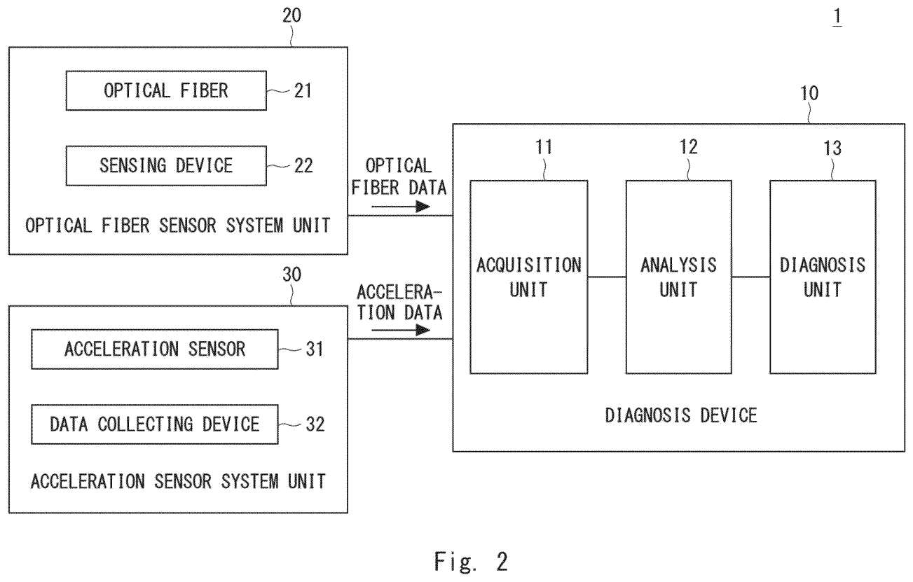

FIG. 2 is a block diagram illustrating a configuration example of the diagnosis system 1 according to the present disclosure.

As illustrated in FIG. 2, the diagnosis system 1 includes a diagnosis device 10, an optical fiber sensor system unit 20, and an acceleration sensor system unit 30.

The optical fiber sensor system unit 20 includes the optical fiber 21 and the sensing device 22 described above.

The optical fiber 21 is laid along the road 40, as described above. The optical fiber 21 may be a communication optical fiber that has been laid in the road 40.

The sensing device 22 is installed in a road management office near the road 40 or the like, for example. As described above, the sensing device 22 senses vibration generated at each position along the road 40, using the optical fiber 21 and generates the optical fiber data indicating the sensed vibration. An optical fiber data generation requirement can be set to the sensing device 22. For example, in the optical fiber data, the horizontal axis indicates a position (distance of optical fiber 21 from sensing device 22 up to the position), and the vertical axis is data indicating a time lapse of the vibration.

The acceleration sensor system unit 30 includes the acceleration sensor 31 and the data collecting device 32 described above.

The acceleration sensor 31 is installed on the information board 42 installed on the road 40 as described above, and measures an acceleration at the installation position.

The data collecting device 32 is installed, for example, near the acceleration sensor 31. The data collecting device 32 collects acceleration data indicating the acceleration measured by the acceleration sensor 31, as described above. For example, the acceleration data is data in which the horizontal axis indicates time and the vertical axis indicates an acceleration.

The diagnosis device 10 is connected to the optical fiber sensor system unit 20 and the acceleration sensor system unit 30 in a wired or wireless manner and includes an acquisition unit 11, an analysis unit 12, and a diagnosis unit 13.

The acquisition unit 11 acquires the optical fiber data representing the vibration generated at each position along the road 40, sensed by the sensing device 22, using the optical fiber 21 laid along the road 40, from the sensing device 22. The acquisition unit 11 acquires the acceleration data indicating the acceleration measured by the acceleration sensor 31 installed on the information board 42 installed on the road 40, from the data collecting device 32.

The analysis unit 12 estimates a traveling state of a vehicle on the road 40, using the optical fiber data acquired from the sensing device 22. Specifically, the analysis unit 12 estimates a time section in which the vehicle has passed through a road section to be monitored, immediately below the information board 42. Next, the analysis unit 12 determines the estimated time section, as an analysis target section in which the acceleration data is analyzed. Next, the analysis unit 12 extracts a diagnostic index from the acceleration data in the analysis target section, among the acceleration data acquired from the data collecting device 32. For example, the diagnostic index may be a maximum acceleration (maximum amplitude of acceleration) in the acceleration data in the analysis target section, a peak frequency in a frequency spectrum obtained by frequency converting the acceleration data in the analysis target section, a spectrum intensity in a specific band in the frequency spectrum, or the like. However, the diagnostic index is not limited to these.

The diagnosis unit 13 diagnoses a state of the information board 42, using the diagnostic index extracted by the analysis unit 12. For example, the diagnosis unit 13 may compare the latest diagnostic index extracted by the analysis unit 12 with a diagnostic index in a past reference period, and diagnose the state of the information board 42, using the comparison result. The diagnosis unit 13 may compare the latest diagnostic index extracted by the analysis unit 12 with a normal range of the diagnostic index and diagnose the state of the information board 42 using the comparison result. The diagnosis unit 13 may compare a statistical value of the diagnostic index in a current period including the latest diagnostic index extracted by the analysis unit 12 with a statistical value of the diagnostic index in a past period and diagnose the state of the information board 42 using the comparison result.

The diagnosis unit 13 displays a diagnosis result of the state of the information board 42 on a display unit (not illustrated). This display unit may be provided in the diagnosis device 10 or may be provided in an external device of the diagnosis device 10.

Here, a specific operation of the diagnosis device 10 will be described.

First, an operation for determining the analysis target section will be described.

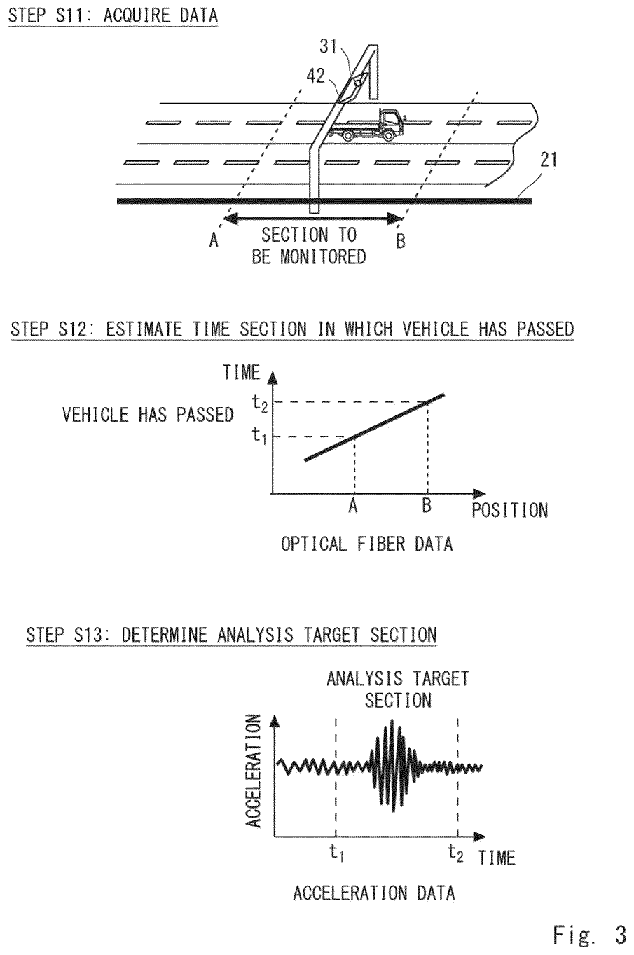

FIG. 3 is a diagram for explaining an operation example for determining the analysis target section, in the diagnosis device 10 according to the present disclosure.

As illustrated in FIG. 3, the acquisition unit 11 acquires the optical fiber data from the sensing device 22 and acquires the acceleration data from the data collecting device 32 (step S11). In FIG. 3, the road section to be monitored immediately below the information board 42 is a road section from a position A to a position B.

Here, the optical fiber data acquired from the sensing device 22 is data in which the horizontal axis indicates a position (distance of optical fiber 21 from sensing device 22 up to the position) and the vertical axis indicates a time lapse of the vibration. In the optical fiber data, a single oblique line indicates that a single vehicle is traveling on the road 40.

Therefore, the analysis unit 12 estimates a time section in which the vehicle has passed through the road section to be monitored (road section from position A to position B) immediately below the information board 42, using the optical fiber data (step S12). In FIG. 3, a single vehicle passes through the position A at a time t₁ and passes through the position B at a time t₂. Therefore, the analysis unit 12 estimates a time section from the time t₁ to the time t₂, as the time section in which the vehicle has passed through the road section to be monitored.

Then, the analysis unit 12 determines the time section estimated in step S12 (time section from time t₁ to time t₂), as the analysis target section in which the acceleration data is analyzed (step S13).

Subsequently, an operation for diagnosing the state of the information board 42 will be described. Hereinafter, three operation examples 1 to 3 will be described.

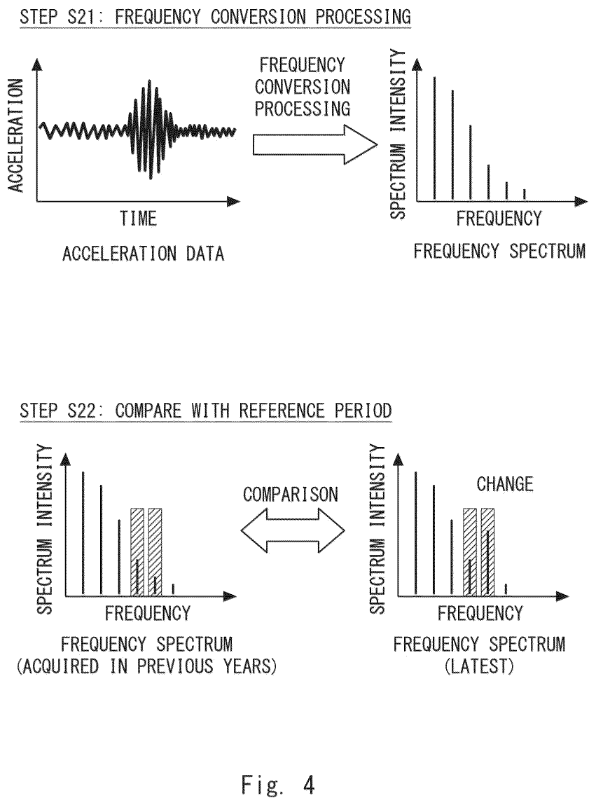

FIG. 4 is a diagram for explaining the operation example 1 for diagnosing the state of the information board 42, in the diagnosis device 10 according to the present disclosure.

The operation example 1 is an example in which the latest diagnostic index is compared with the diagnostic index in the past reference period, and the state of the information board 42 is diagnosed, using the comparison result. In the operation example 1, it is assumed that the diagnostic index be the spectrum intensity in the specific band in the frequency spectrum.

As illustrated in FIG. 4, the analysis unit 12 calculates the frequency spectrum, by executing frequency conversion processing on the acceleration data in the analysis target section, and extracts the spectrum intensity in the specific band in the calculated frequency spectrum, as the diagnostic index (step S21).

The diagnosis unit 13 acquires and holds, in advance, the spectrum intensity in the specific band in the frequency spectrum in the past reference period. Therefore, the diagnosis unit 13 compares a spectrum intensity in a specific band in a latest frequency spectrum with the spectrum intensity in the specific band in the frequency spectrum in the past reference period and diagnoses the state of the information board 42, using the comparison result (step S22). In FIG. 4, the spectrum intensity changes from the past reference period, in a part of the specific band. Therefore, for example, in a case where a change rate of the spectrum intensity exceeds a threshold, the diagnosis unit 13 may diagnose that the information board 42 is in an abnormal state.

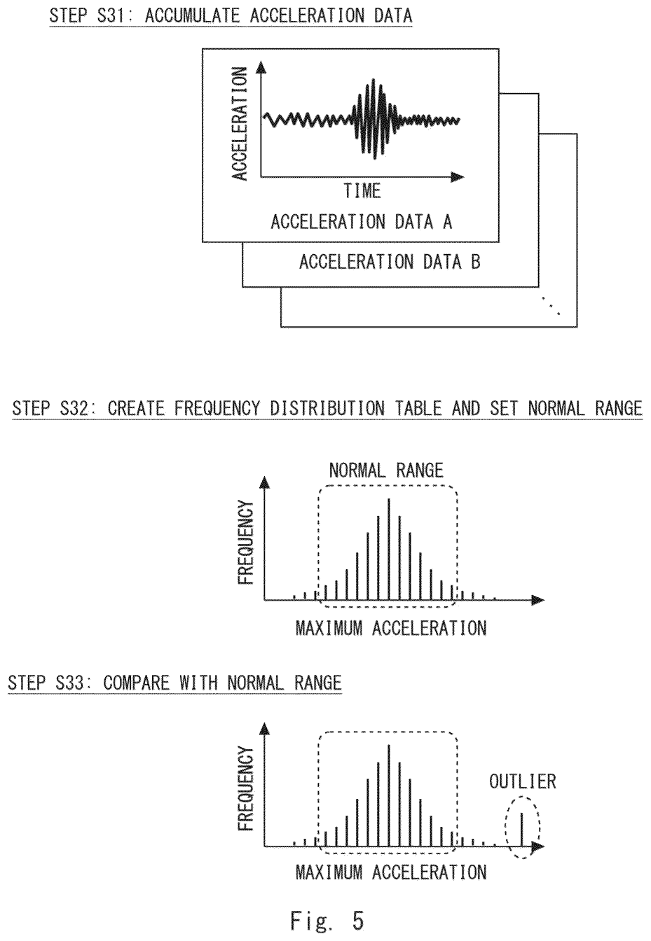

FIG. 5 is a diagram for explaining the operation example 2 for diagnosing the state of the information board 42, in the diagnosis device 10 according to the present disclosure.

The operation example 2 is an example in which the latest diagnostic index is compared with the normal range of the diagnostic index and the state of the information board 42 is diagnosed, using the comparison result. In the operation example 2, it is assumed that the diagnostic index be a maximum acceleration in the acceleration data in the analysis target section.

As illustrated in FIG. 5, the analysis unit 12 repeatedly acquires the acceleration data in the analysis target section over a long period and accumulates the acceleration data (step S31).

The analysis unit 12 extracts the maximum acceleration, from each piece of the accumulated acceleration data in the analysis target section, as the diagnostic index. The diagnosis unit 13 creates a frequency distribution table of the maximum acceleration extracted as the diagnostic index and sets a normal range of the maximum acceleration (step S32).

Thereafter, in a case where the analysis unit 12 extracts the latest maximum acceleration as the diagnostic index, the diagnosis unit 13 compares the latest maximum acceleration with the normal range of the maximum acceleration and diagnoses the state of the information board 42, using the comparison result (step S33). In FIG. 5, the latest maximum acceleration is an outlier outside the normal range. Therefore, the diagnosis unit 13 diagnoses that the information board 42 is in an abnormal state.

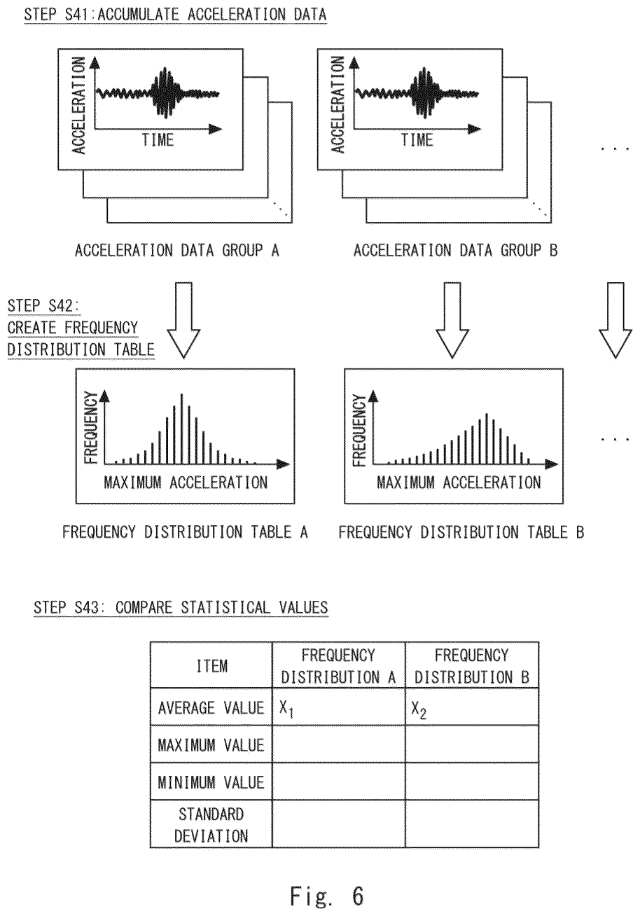

FIG. 6 is a diagram for explaining the operation example 3 for diagnosing the state of the information board 42, in the diagnosis device 10 according to the present disclosure.

The operation example 3 is an example in which the statistical value of the diagnostic index in the current period including the latest diagnostic index is compared with the statistical value of the diagnostic index in the past period, and the state of the information board 42 is diagnosed, using the comparison result. In the operation example 3, it is assumed that the diagnostic index be the maximum acceleration in the acceleration data in the analysis target section.

As illustrated in FIG. 6, the analysis unit 12 repeatedly acquires the acceleration data in the analysis target section, every certain period, and accumulates the acceleration data (step S41). In FIG. 6, the analysis unit 12 accumulates an acceleration data group A in a certain period and accumulates an acceleration data group B in a next certain period.

The analysis unit 12 extracts the maximum acceleration, as the diagnostic index, from each piece of the accumulated acceleration data in the analysis target section, for each certain period. The diagnosis unit 13 creates a frequency distribution table of the maximum acceleration extracted as the diagnostic index, every certain period (step S42). In FIG. 6, the diagnosis unit 13 creates a frequency distribution table A, for the acceleration data group A in the certain period and creates a frequency distribution table B, for the acceleration data group B in the next certain period.

Thereafter, the diagnosis unit 13 calculates an average value of the frequency distribution table of the maximum acceleration, as the statistical value, every certain period. Then, the diagnosis unit 13 compares an average value of a frequency distribution table of the maximum acceleration in a current certain period including the latest maximum acceleration with an average value of a frequency distribution table of the maximum acceleration in a past certain period, and diagnoses the state of the information board 42, using the comparison result (step S43). In FIG. 6, while an average value of the frequency distribution table B of the maximum acceleration in the current certain period is x₂, an average value of the frequency distribution table A of the maximum acceleration in the previous certain period is x₁. Therefore, for example, in a case where x₂/x₁ is two or more, the diagnosis unit 13 may diagnose that the information board 42 is in an abnormal state. Although the statistical value is the average value in FIG. 6, the statistical value is not limited to this. The statistical value may be a maximum value, a minimum value, a standard deviation, or the like.

Subsequently, a flow of the operation of the diagnosis device 10 will be described.

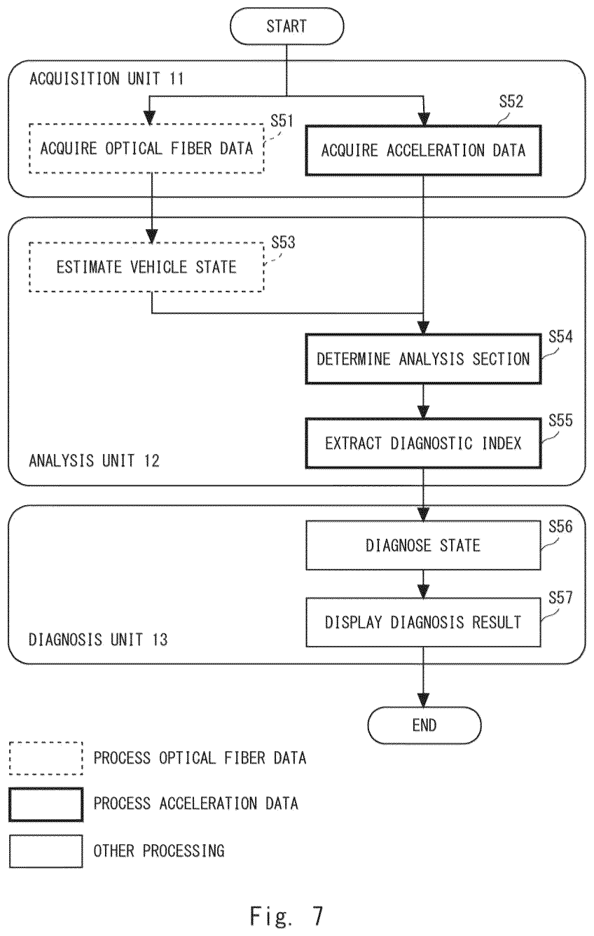

FIG. 7 is a flowchart for explaining an example of the flow of the operation of the diagnosis device 10 according to the present disclosure.

As illustrated in FIG. 7, first, the acquisition unit 11 acquires the optical fiber data from the sensing device 22 (step S51). The acquisition unit 11 acquires the acceleration data from the data collecting device 32 (step S52).

Next, the analysis unit 12 estimates the traveling state of the vehicle on the road 40, using the optical fiber data acquired in step S51 (step S53). Specifically, the analysis unit 12 estimates the time section in which the vehicle has passed through the road section to be monitored, immediately below the information board 42.

Next, the analysis unit 12 determines the time section estimated in step S53, as the analysis target section of which the acceleration data is analyzed (step S54).

Next, the analysis unit 12 extracts the diagnostic index from the acceleration data in the analysis target section, among the acceleration data acquired in step S52 (step S55).

Next, the diagnosis unit 13 diagnoses the state of the information board 42, using the diagnostic index extracted in step S55 (step S56).

Thereafter, the diagnosis unit 13 displays a diagnosis result of the state of the information board 42 diagnosed in step S56, on a display unit (not illustrated) (step S57).

As described above, according to the first example embodiment, the diagnosis device 10 estimates the time section in which the vehicle has passed through the road section to be monitored immediately below the information board 42, using the optical fiber data and determines the estimated time section, as the analysis target section in which the acceleration data is analyzed. The diagnosis device 10 extracts the diagnostic index from the acceleration data in the analysis target section and diagnoses the state of the information board 42, using the extracted diagnostic index.

Therefore, the state of the information board 42 can be diagnosed, using the acceleration data in the time section in which the vehicle travels immediately below the information board 42 and the information board 42 receives an excitation force caused by a traffic stream. From this, since erroneous diagnosis of the information board 42 caused by an environmental factor such as wind can be reduced, it is possible to contribute to improve a diagnosis performance of the information board 42.

Here, the present inventors or the like have verified the effect of the first example embodiment, using the actual information board 42. For comparison with the first example embodiment, an effect of the related art using the technology disclosed in JP 2021-021647 A has been also verified.

First, the verification regarding the related art will be described.

Before the information board 42 is damaged, a correlation between the acceleration and strain is calculated, using an acceleration sensor and a strain measurement sensor installed on a support post to which the information board 42 is attached. Thereafter, the strain is derived from the acceleration, using the correlation, and a stress applied to the support post and the number of times of stress generation are estimated. In a case where the number of times of stress generation exceeds a threshold, it is diagnosed that the information board 42 is damaged.

Subsequently, the verification performed regarding the first example embodiment will be described.

In a reference period before the information board 42 is damaged, the acceleration data in the analysis target section is derived, using the optical fiber 21 laid on the road 40 and the acceleration sensor 31 installed on the information board 42. Then, the spectrum intensity in the specific band in the frequency spectrum obtained by frequency converting the acceleration data in the analysis target section is extracted as the diagnostic index. Thereafter, the spectrum intensity is similarly extracted, and in a case where a change rate with respect to the spectrum intensity in the reference period exceeds a threshold, it is diagnosed that the information board 42 is damaged.

Then, at the time point upon the damage of the information board 42 is visually confirmed, it is confirmed whether it can be correctly diagnosed that the information board 42 is damaged using the above method, for each of the related art and the first example embodiment.

As a result, the related art has erroneously diagnosed that the information board 42 has no damage. The reason for this is estimated to be that, since an erroneous correlation is calculated using the acceleration and the strain in a case where the information board 42 receives the excitation force caused by the environment, the strain is estimated to be smaller with respect to the acceleration.

On the other hand, in the first example embodiment, it can be correctly diagnosed that the information board 42 is damaged. The reason for this is considered that the state of the information board 42 is diagnosed, using the acceleration data in the time section in which the information board 42 receives the excitation force caused by the traffic stream.

Although the road accessory is the information board 42 in the first example embodiment, the road accessory is not limited to this. It is sufficient that the road accessory may be any object that vibrates by receiving the excitation force caused by the traffic stream, and for example, a road sign, a road lighting, or the like may be used.

### Second Example Embodiment

A second example embodiment corresponds to an example embodiment that is a superordinate concept of the first example embodiment described above.

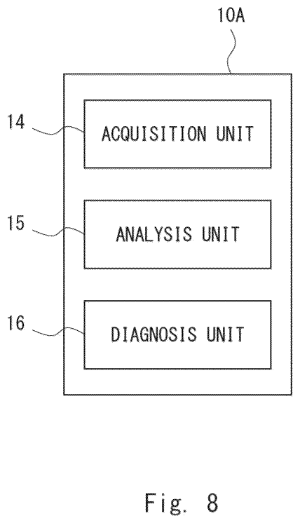

FIG. 8 is a block diagram illustrating a configuration example of a diagnosis device 10A according to the present disclosure.

As illustrated in FIG. 8, the diagnosis device 10A includes an acquisition unit 14, an analysis unit 15, and a diagnosis unit 16.

The acquisition unit 14 acquires optical fiber data indicating vibration sensed by using an optical fiber laid along a road and acquires acceleration data indicating an acceleration measured by an acceleration sensor installed in a road accessory installed on the road.

The analysis unit 15 estimates a time section in which a vehicle has passed through a road section near the road accessory, using the optical fiber data and determines the estimated time section, as an analysis target section in which the acceleration data is analyzed.

The diagnosis unit 16 diagnoses a state of the road accessory, using the acceleration data in the analysis target section.

Therefore, the state of the road accessory can be diagnosed, using the acceleration data in the time section in which the vehicle travels near the road accessory and the road accessory receives an excitation force caused by a traffic stream. From this, since erroneous diagnosis of the road accessory caused by an environmental factor such as wind can be reduced, it is possible to contribute to improving a diagnosis performance of the road accessory.

The analysis unit 15 may extract a diagnostic index from the acceleration data in the analysis target section. The diagnosis unit 16 may diagnose the state of the road accessory, using the extracted diagnostic index.

The analysis unit 15 may extract a maximum acceleration in the acceleration data in the analysis target section, as the diagnostic index. The analysis unit 15 may extract a peak frequency in a frequency spectrum obtained by frequency converting the acceleration data in the analysis target section, as the diagnostic index. The analysis unit 15 may extract a spectrum intensity in a specific band in the frequency spectrum obtained by frequency converting the acceleration data in the analysis target section, as the diagnostic index.

The diagnosis unit 16 may compare an extracted latest diagnostic index with a diagnostic index in a past reference period, and diagnose the state of the road accessory, using the comparison result. The diagnosis unit 16 may compare the extracted latest diagnostic index with a normal range of the diagnostic index and diagnose the state of the road accessory, using the comparison result. The diagnosis unit 16 may compare a statistical value of a diagnostic index in a current period including the extracted latest diagnostic index with a statistical value of the diagnostic index in a past period and diagnose the state of the road accessory, using the comparison result.

### Other Example Embodiments

Although the plurality of components is provided in the diagnosis devices 10 and 10A in the first and second example embodiments, the present disclosure is not limited to this. In the present disclosure, the plurality of components may be provided in a plurality of devices in a distributed manner. That is, the present disclosure may be achieved by a system including a plurality of devices.

### Hardware Configuration of Diagnosis Device according to Present Disclosure

Next, a hardware configuration of a computer that achieves the diagnosis devices 10 and 10A according to the present disclosure will be described.

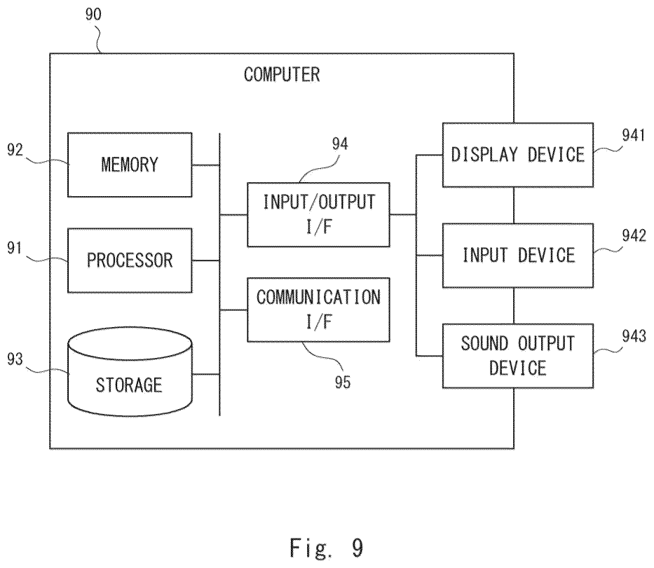

FIG. 9 is a block diagram illustrating a hardware configuration example of a computer 90 that achieves the diagnosis devices 10 and 10A according to the present disclosure.

As illustrated in FIG. 9, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a Central Processing Unit (CPU) or a Graphics Processing Unit (GPU). The memory 92 is, for example, a memory such as a Random Access Memory (RAM) or a Read Only Memory (ROM). The storage 93 is, for example, a storage device such as a Hard Disk Drive (HDD), a Solid State Drive (SSD), or a memory card. The storage 93 may be a memory such as the RAM or the ROM.

A program is stored in the storage 93. This program includes an instruction group (or software code) for causing the computer 90 to perform one or more functions in the above-described diagnosis devices 10 and 10A in a case of being read by the computer. The components in the above-described diagnosis devices 10 and 10A may be achieved by the processor 91 reading and executing the program stored in the storage 93. A storage function in the diagnosis devices 10 and 10A described above may be achieved by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, and the like. The display device 941 is a device that displays a screen related to drawing data processed by the processor 91, such as a Liquid Crystal Display (LCD), a Cathode Ray Tube (CRT) display, or a monitor. The input device 942 is a device that receives operator's operation input, and is, for example, a keyboard, a mouse, a touch sensor, or the like. The display device 941 and the input device 942 may be integrated and achieved as a touch panel. The sound output device 943 is a device that acoustically outputs a sound related to acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A diagnosis device including:
at least one memory storing instructions; and
at least one processor configured to execute the instructions to:
acquire optical fiber data indicating vibration sensed using an optical fiber laid along a road and acquire acceleration data indicating an acceleration measured by an acceleration sensor installed on a road accessory installed on the road;
estimate a time section in which a vehicle has passed through a road section near the road accessory, using the optical fiber data and determine the estimated time section as an analysis target section in which the acceleration data is analyzed; and
diagnose a state of the road accessory, using the acceleration data in the analysis target section.

### (Supplementary Note 2)

The diagnosis device according to supplementary note 1, in which
the at least one processor is configured to execute the instructions to:
extract a diagnostic index from the acceleration data in the analysis target section and
diagnose the state of the road accessory, using the extracted diagnostic index.

### (Supplementary Note 3)

The diagnosis device according to supplementary note 2, in which the at least one processor is configured to execute the instructions to extract a maximum acceleration in the acceleration data in the analysis target section, as the diagnostic index.

### (Supplementary Note 4)

The diagnosis device according to supplementary note 2, in which the at least one processor is configured to execute the instructions to extract a peak frequency in a frequency spectrum obtained by frequency converting the acceleration data in the analysis target section, as the diagnostic index.

### (Supplementary Note 5)

The diagnosis device according to supplementary note 2, in which the at least one processor is configured to execute the instructions to extract a spectrum intensity in a specific band in a frequency spectrum obtained by frequency converting the acceleration data in the analysis target section, as the diagnostic index.

### (Supplementary Note 6)

The diagnosis device according to supplementary note 2, in which the at least one processor is configured to execute the instructions to compare the extracted latest diagnostic index with the diagnostic index in a past reference period and diagnose the state of the road accessory, using a comparison result.

### (Supplementary Note 7)

The diagnosis device according to supplementary note 2, in which the at least one processor is configured to execute the instructions to compare the extracted latest diagnostic index with a normal range of the diagnostic index and diagnose the state of the road accessory, using a comparison result.

### (Supplementary Note 8)

The diagnosis device according to supplementary note 2, in which the at least one processor is configured to execute the instructions to compare a statistical value of the diagnostic index in a current period including the extracted latest diagnostic index with a statistical value of the diagnostic index in a past period and diagnose the state of the road accessory, using a comparison result.

### (Supplementary Note 9)

A diagnosis method executed by a diagnosis device, including:
acquiring optical fiber data indicating vibration sensed using an optical fiber laid along a road and acquiring acceleration data indicating an acceleration measured by an acceleration sensor installed on a road accessory installed on the road;
estimating a time section in which a vehicle has passed through a road section near the road accessory, using the optical fiber data and determining the estimated time section as an analysis target section in which the acceleration data is analyzed; and
diagnosing a state of the road accessory, using the acceleration data in the analysis target section.

### (Supplementary Note 10)

A non-transitory computer-readable medium storing a program for causing a computer to execute:
a procedure for acquiring optical fiber data indicating vibration sensed using an optical fiber laid along a road and acquiring acceleration data indicating an acceleration measured by an acceleration sensor installed on a road accessory installed on the road;
a procedure for estimating a time section in which a vehicle has passed through a road section near the road accessory, using the optical fiber data and determining the estimated time section as an analysis target section in which the acceleration data is analyzed; and
a procedure for diagnosing a state of the road accessory, using the acceleration data in the analysis target section.

Note that, some or all of elements (e.g., structures and functions) specified in Supplementary Notes 2 to 8 dependent on Supplementary Note 1 may also be dependent on Supplementary Note 9 and Supplementary Note 10 in dependency similar to that of Supplementary Notes 2 to 8 dependent on Supplementary Note 1. Some or all of elements specified in any of Supplementary Notes may be applied to various types of hardware, software, and recording means for recording software, systems, and methods.

What is claimed is:

1. A diagnosis device comprising:
at least one memory storing instructions; and
at least one processor configured to execute the instructions to:
acquire optical fiber data indicating vibration sensed using an optical fiber laid along a road and acquire acceleration data indicating an acceleration measured by an acceleration sensor installed on a road accessory installed on the road;
estimate a time section in which a vehicle has passed through a road section near the road accessory, using the optical fiber data and determine the estimated time section as an analysis target section in which the acceleration data is analyzed; and
diagnose a state of the road accessory, using the acceleration data in the analysis target section.

2. The diagnosis device according to claim 1, wherein
the at least one processor is configured to execute the instructions to:
extract a diagnostic index from the acceleration data in the analysis target section and
diagnose the state of the road accessory, using the extracted diagnostic index.

3. The diagnosis device according to claim 2, wherein the at least one processor is configured to execute the instructions to extract a maximum acceleration in the acceleration data in the analysis target section, as the diagnostic index.

4. The diagnosis device according to claim 2, wherein the at least one processor is configured to execute the instructions to extract a peak frequency in a frequency spectrum obtained by frequency converting the acceleration data in the analysis target section, as the diagnostic index.

5. The diagnosis device according to claim 2, wherein the at least one processor is configured to execute the instructions to extract a spectrum intensity in a specific band in a frequency spectrum obtained by frequency converting the acceleration data in the analysis target section, as the diagnostic index.

6. The diagnosis device according to claim 2, wherein the at least one processor is configured to execute the instructions to compare the extracted latest diagnostic index with the diagnostic index in a past reference period and diagnose the state of the road accessory, using a comparison result.

7. The diagnosis device according to claim 2, wherein the at least one processor is configured to execute the instructions to compare the extracted latest diagnostic index with a normal range of the diagnostic index and diagnose the state of the road accessory, using a comparison result.

8. The diagnosis device according to claim 2, wherein the at least one processor is configured to execute the instructions to compare a statistical value of the diagnostic index in a current period including the extracted latest diagnostic index with a statistical value of the diagnostic index in a past period and diagnose the state of the road accessory, using a comparison result.

9. A diagnosis method executed by a diagnosis device, comprising:
acquiring optical fiber data indicating vibration sensed using an optical fiber laid along a road and acquiring acceleration data indicating an acceleration measured by an acceleration sensor installed on a road accessory installed on the road;
estimating a time section in which a vehicle has passed through a road section near the road accessory, using the optical fiber data and determining the estimated time section as an analysis target section in which the acceleration data is analyzed; and
diagnosing a state of the road accessory, using the acceleration data in the analysis target section.

10. A non-transitory computer-readable medium storing a program for causing a computer to execute:
a procedure for acquiring optical fiber data indicating vibration sensed using an optical fiber laid along a road and acquiring acceleration data indicating an acceleration measured by an acceleration sensor installed on a road accessory installed on the road;
a procedure for estimating a time section in which a vehicle has passed through a road section near the road accessory, using the optical fiber data and determining the estimated time section as an analysis target section in which the acceleration data is analyzed; and
a procedure for diagnosing a state of the road accessory, using the acceleration data in the analysis target section.
